(19) United States
(12) Patent Application Publication
(10) Pub. No.: US 2016/0288998 A1
(43) Pub. Date: Oct. 6, 2016

(54) WASTE MANAGEMENT CART WITH ADVERTISING PANELS

(71) Applicant: JUNK BUNK INC., Aurora (CA)

(72) Inventor: Gary Daniell, Aurora (CA)

(21) Appl. No.: 15/088,489

(22) Filed: Apr. 1, 2016

Related U.S. Application Data
(60) Provisional application No. 62/141,901, filed on Apr. 2, 2015.

(51) Int. Cl. B65F 1/14; B62B 3/00; B60R 13/00; B65F 1/00

(52) U.S. Cl. CPC B65F 1/1468; B65F 1/0053; B62B 3/005; B60R 13/00; B65F 2001/1489

(57) ABSTRACT

Provided is a cart for transporting waste management containers including containers for garbage, recyclable materials, and compost. The cart comprises a frame having vertical supports, a set of wheels attached to the frame for transporting the cart, an upper shelf and a lower shelf for supporting the waste management containers, the upper shelf and the lower shelf having at least one substantially open side to allow for insertion and removal of the waste management containers, and at least one advertising panel removably attachable to the vertical supports for the primary purpose of displaying advertising, the advertising panel being sized to substantially cover a side of the cart to provide an increased surface for displaying advertising.

### TECHNICAL FIELD

The disclosure herein relates to waste management carts, and in particular to carts for transporting waste management containers including containers for garbage, recyclable materials, and compost.

### BACKGROUND

Waste management is the generation, prevention, characterization, monitoring, treatment, handling, reuse and residual disposition of solid wastes. There are various types of solid waste including municipal (residential, institutional, commercial), agricultural, and special (health care, household hazardous wastes, sewage sludge). Waste management includes materials produced by human activity, and the process is generally undertaken to reduce their effect on health, the environment or aesthetics.

More or less consistent with the rise of consumables and disposable products governments began to pass anti-dumping ordinances and introduce weekly curbside collection. Residents use a variety of refuse containers to facilitate curbside collection. As waste management practices are introduced with the aim of reducing landfill impacts, a range of container types, mostly made of durable plastic, came to be introduced to facilitate the proper diversion of the waste stream. Such containers include blue boxes, green bins, and garbage bins.

For example, recycling bins or blue boxes are for storing, recyclable materials such as cardboard, boxboard, cans, glass bottles, jars, paper, plastic containers, and plastic bags.

For example, compost, organic, or green wins are for storing biodegradable wastes such as food waste, paper and other products, houseplant waste, paper bags, pet waste, sawdust, shredded paper, and wood ashes.

For example, garbage bins are for storing garbage materials which include most other types of non-recyclable and non-compostable materials.

With the increase diversity in materials and waste streams, there is a need for waste management cart to transport and store the various waste management containers.

### SUMMARY

According to one aspect, there is provided a cart including frame, a set of wheels attached to the frame for transporting the cart, an upper shelf and a lower shelf for supporting waste management items, and at least one advertising panel attached to the frame for displaying advertising.

According to one aspect, there is provided a cart for transporting waste management containers including containers for garbage, recyclable materials, and compost. The cart includes a frame having vertical supports, a set of wheels attached to the frame for transporting the cart, an upper shelf and a lower shelf for supporting the waste management containers, the upper shelf and the lower shelf having at least one substantially open side to allow for insertion and removal of the waste management containers, and at least one advertising panel removably attachable to the frame for the sole purpose of displaying advertising, the advertising panel being sized to substantially cover a side of the cart to provide an increased surface for displaying advertising.

The cart may further include a plurality of panel attachment col lars for attaching the advertising panel to the vertical supports of the frame, each of the panel attachment collars being located at a corner of the advertising panel, and a plurality of bushings for providing a friction fit between the panel attachment collars and the vertical supports.

The plurality of bushings may he clipped together over the vertical supports and the advertising panels may be slid over the bushings and the vertical supports such that the panel attachment collars fit with the bushings.

The advertising panel may include a decal for displaying an advertisement.

The at least one advertising panel may include two advertising panels. The two advertising panels may include a first advertising panel at a first side of the frame and a second advertising panel at a second side of the frame, the second side being opposed to the first side.

The cad may further include a handle located at an upper end of the frame.

The waste management containers are any one or more of garbage bins, green bins, and recycling bins. The lower shelf may be sized to hold two green bins, and the upper shelf may be sized to hold two recycling containers, The upper shelf may be configured to support bins of recycling materials, the lower shelf may he configured to support bins for organic material, and the side shelf may be configured to support bins for garbage material.

The set of wheels may include two front wheels and two rear wheels. The front two wheels may include locking mechanisms for preventing rotation of the wheels. The set of wheels may he swivel wheels.

The upper shelf may include left, right, and rear rails to inhibit the waste management items from falling off of the upper shelf. The upper shelf may include an open front side for allowing access to the upper shelf.

The cart may further include a side shelf at a lower end of a left end of the cart.

The cart may further include an expanded section of the lower shelf and a tie-down extending from the upper shelf or frame to secure the expanded section of the lower shelf.

The upper and lower shelf each may include a plurality of ribs for reinforcing the shelf. The shell may include three ribs running in a first direction andtwo ribs running in a direction perpendicular to the three ribs.

The advertising panel may include metal sheet of 0.5 mm to 4 mm.

According to one aspect, there is provided a method for assembling the cart. The method includes attaching a frame to a lower shelf, attaching the frame to the upper shelf, and attaching at least one advertising panel to the frame.

Other aspects and features will become apparent, to those ordinarily skilled in the art, upon review of the following description of some exemplary embodiments.

### BRIEF DESCRIPTION OF THE DRAWINGS

Some embodiments of the the present specification will now be described, by way of example only, with reference to the following drawings, in which:

FIG. 1 is a front perspective view of a cart, according to one embodiment;

FIG. 2 is a left side view of the cart of FIG. 1;

FIG. 3 is a front view of the cart of FIG. 1;

FIG. 4 is a right side view of the cart of FIG. 1;

FIG. 5 is a rear view of the cart of FIG. 1;

FIG. 6 is a top view of the cart of FIG. 1;

FIG. 7 is a bottom view of the cart of FIG. 1;

FIG. 8 is a front perspective view of the cart of FIG. 1 carrying containers,

FIG. 9 is a front view of the cart of FIG. 1 carrying containers;

FIGS. 10A-10J is a flow chart of a method for assembling a cart, in accordance with an embodiment; and

FIG. 11 is a perspective view of a shelf for the cart of FIG. 1.

### DETAILED DESCRIPTION

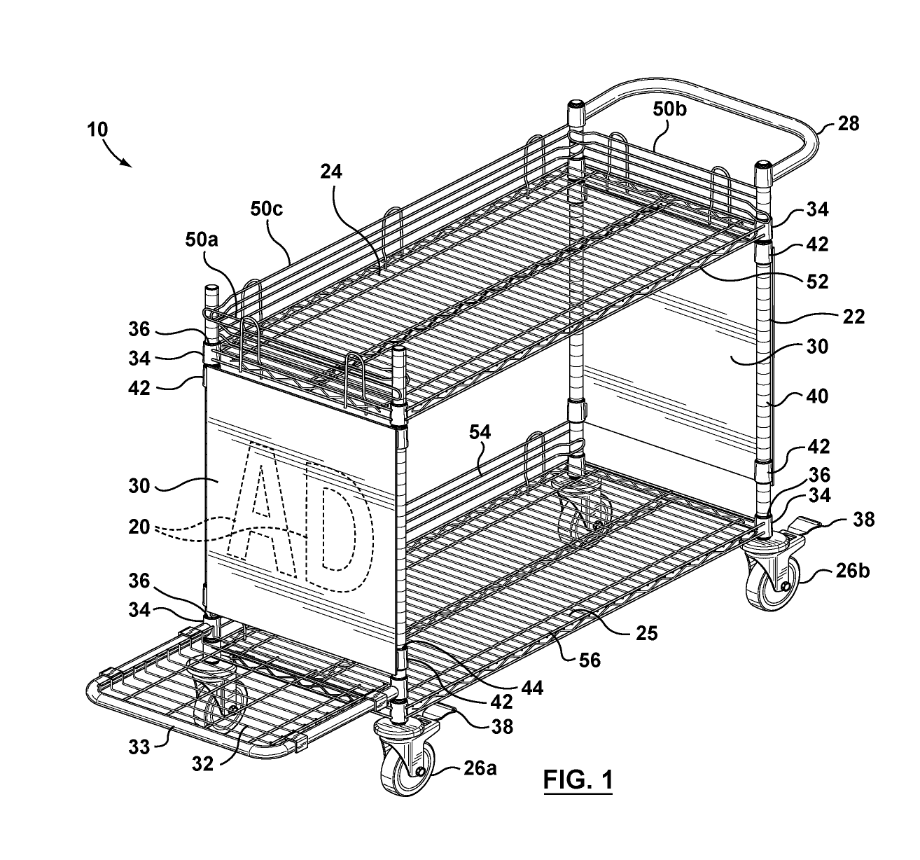

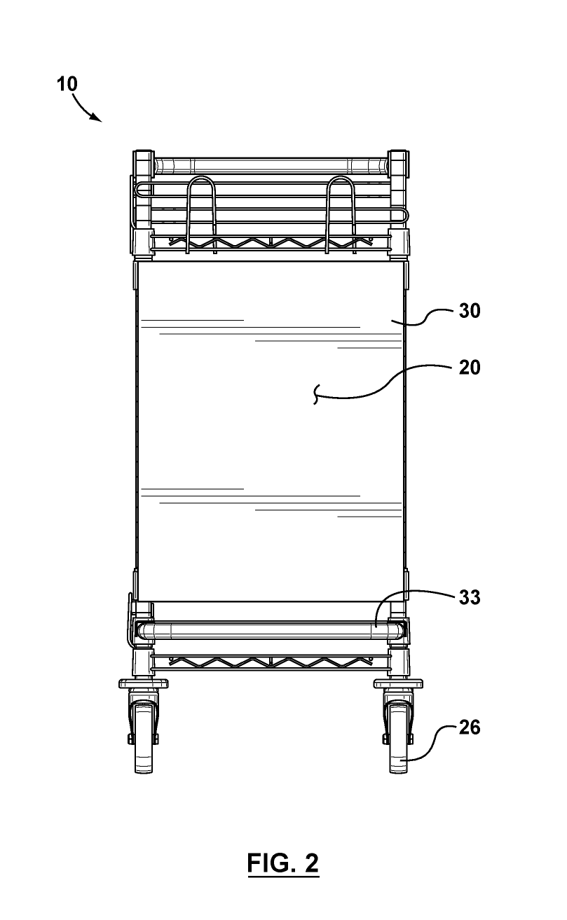

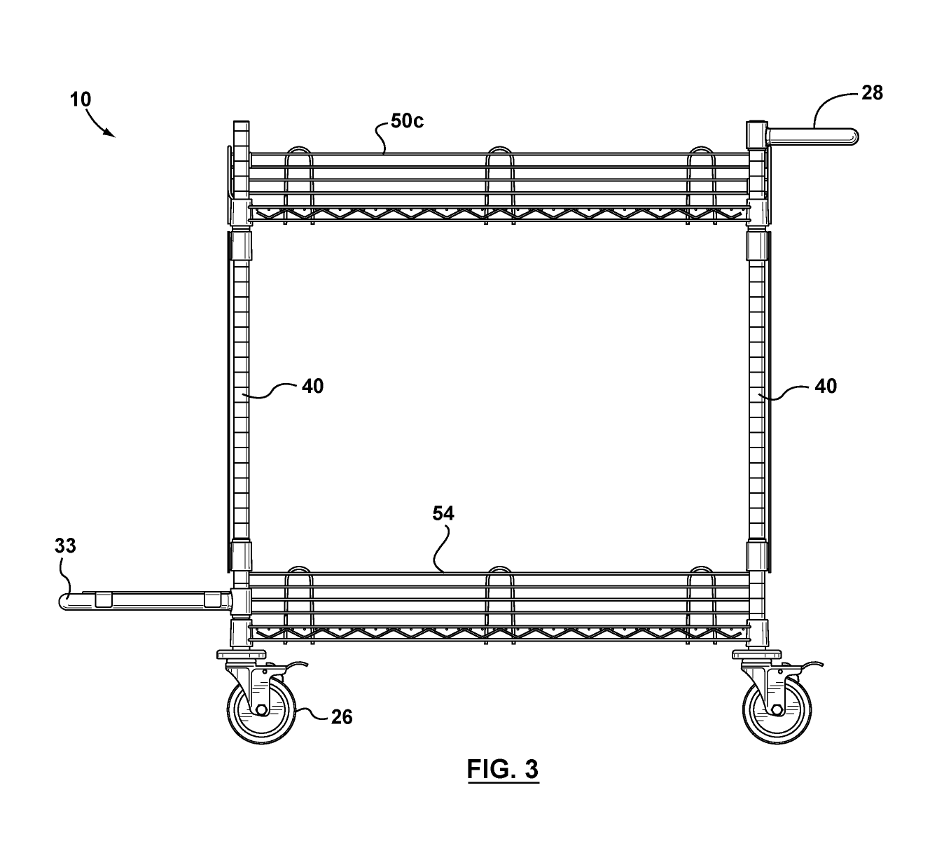

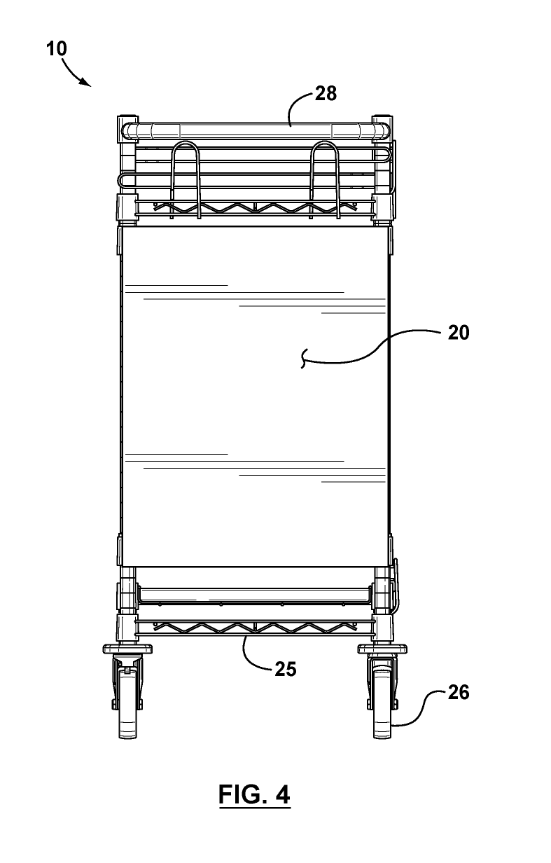

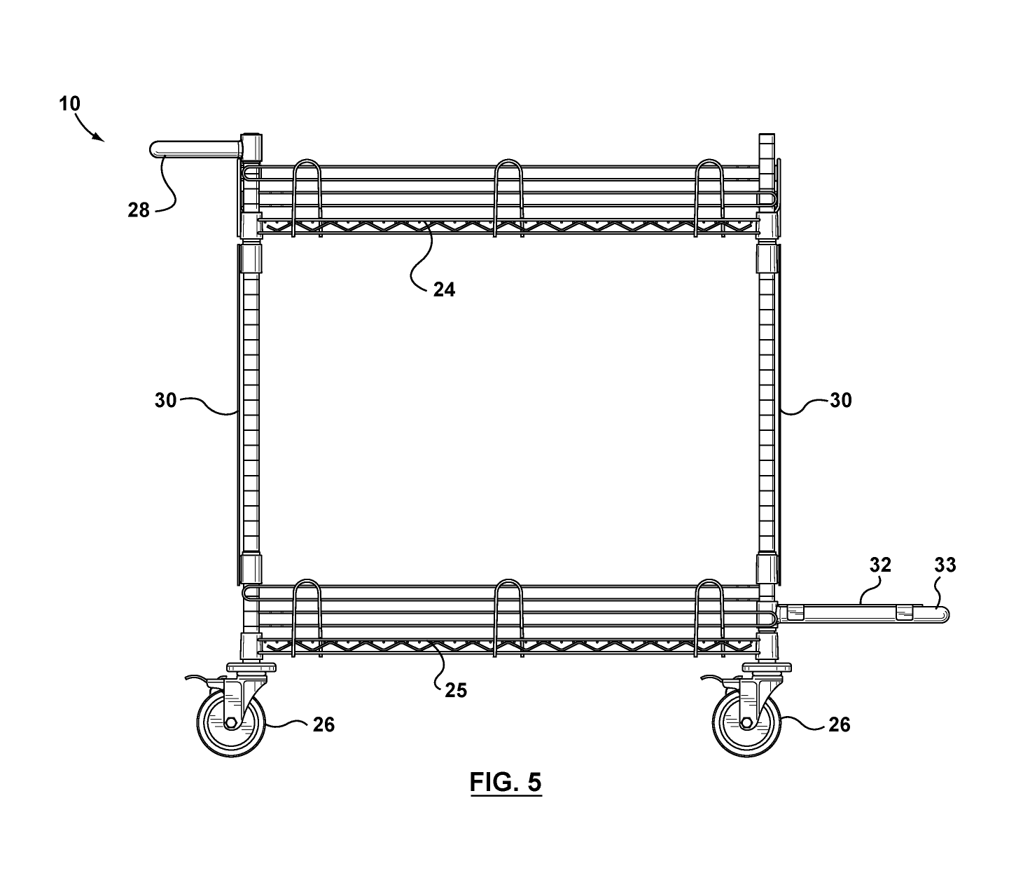

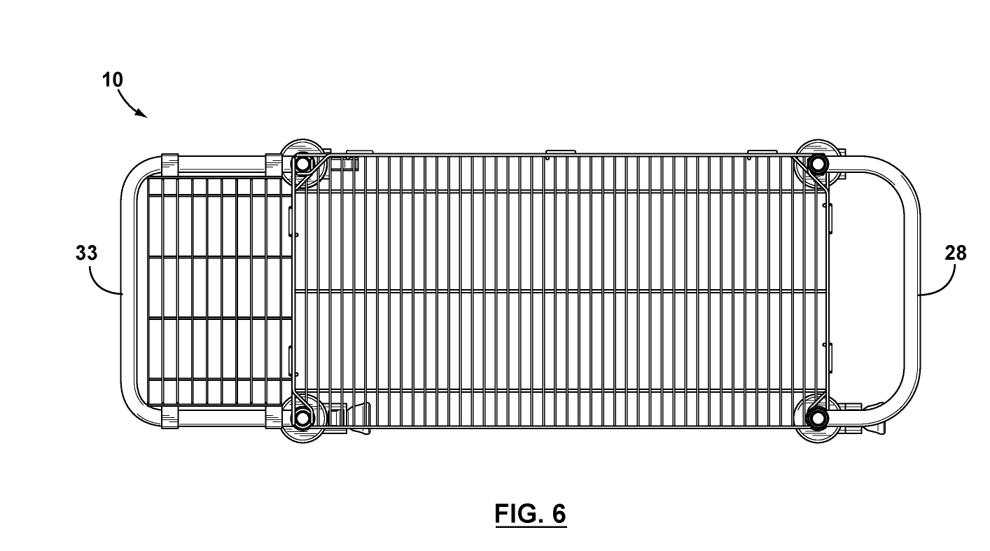

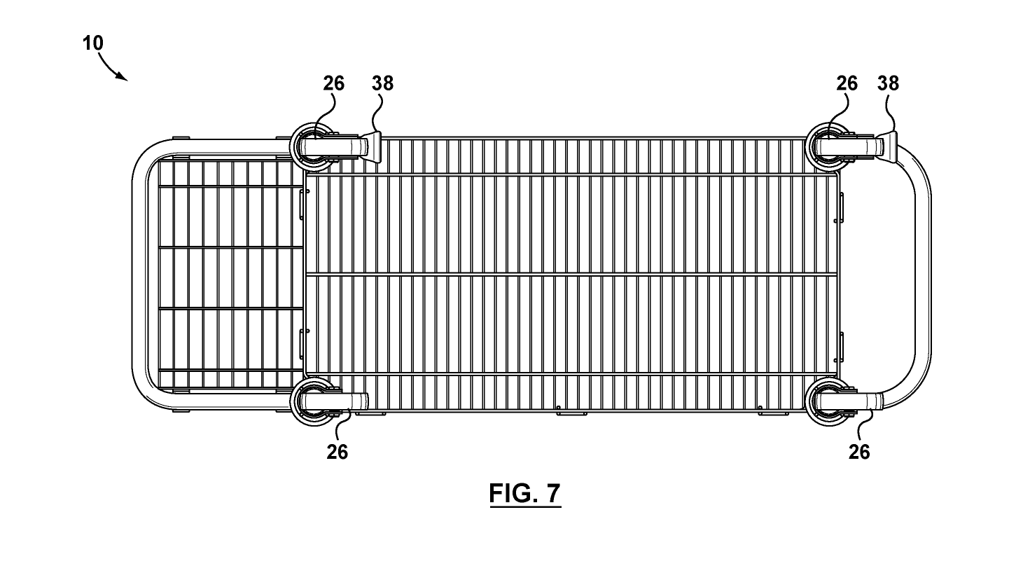

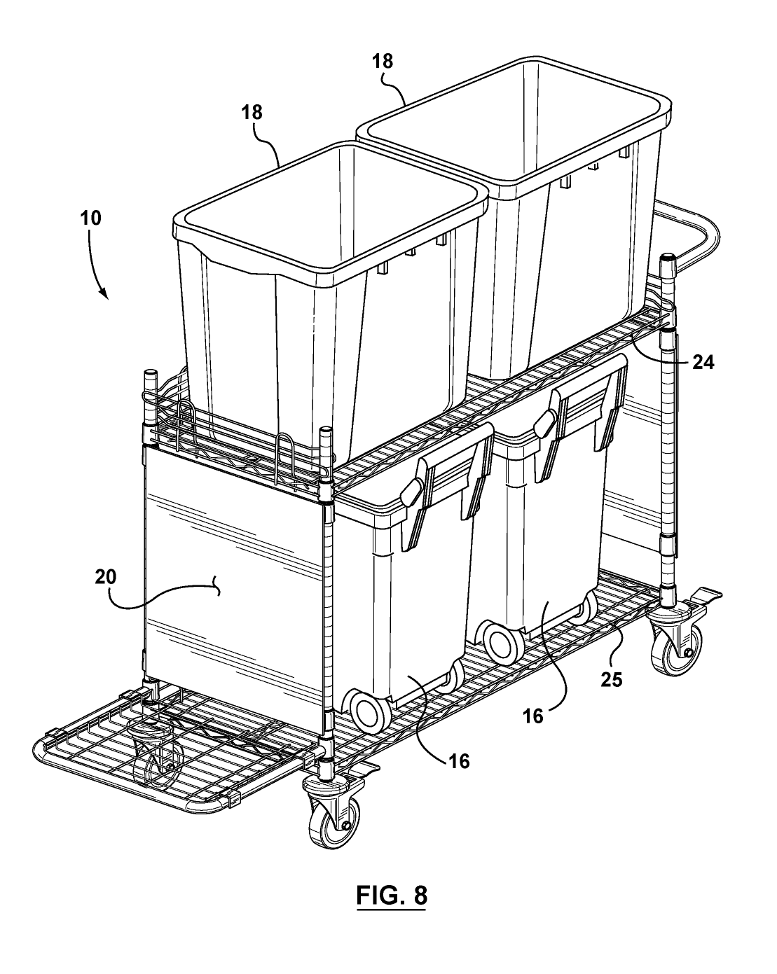

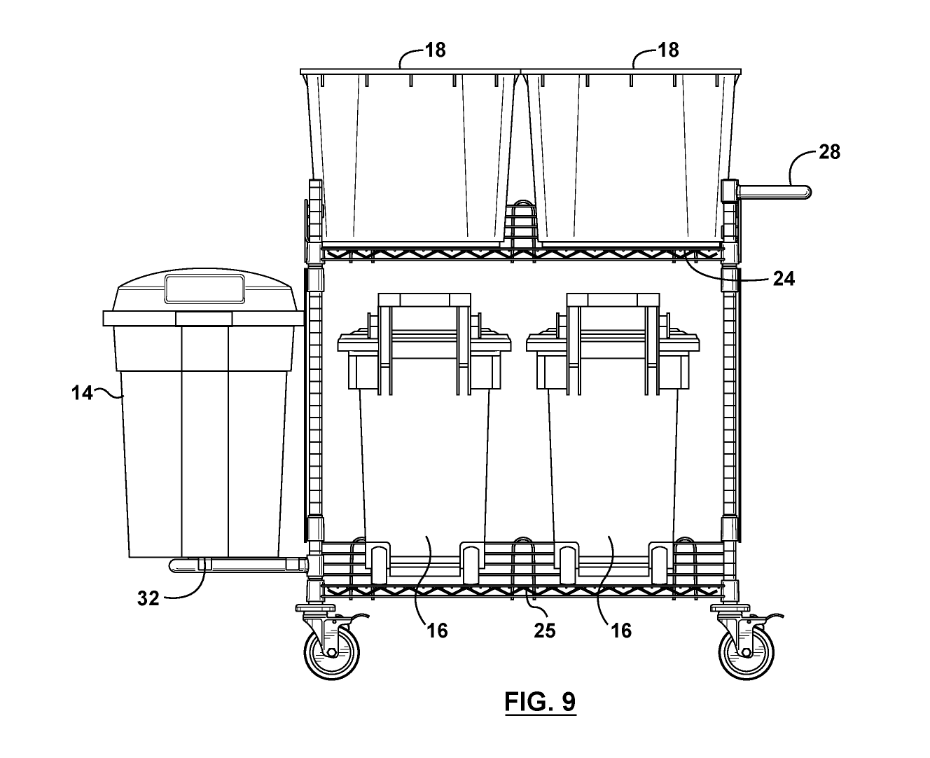

Referring to FIGS. 1-9, illustrated therein is a cart 10 for carrying and storing items or containers, such as oarbage bins 14, green bins 16, and recycling bins 18 (shown in FIGS. 8 and 9), while displaying advertising 20. The cart 10 can be used to store the items 14, 16, 18 and transport the items 14, 16, 18 to a pick-up location, for example a street curb for curb-side pick-up. The cart 10 can also be used in other situations, such as street sales, garage sales, and bake sales. The cart 10 provides advertising 20 in visible locations, such as on the curb-side of a residential or commercial area, such as on a weekly waste-collection day. The cart 10 can be used in service industries such as in hotels, hospitals, and offices. The cart 10 can provide multiple container configurations to suit individual waste requirements.

The cart 10 can also he used to store the items 14, 16, 18 and organize and save space in storage areas such as in a garage or shed and the cart 10 can keep the pick-up location organized on waste-collection day. The cart 10 can make it easier for waste collectors to pick up and empty containers from the cart 10 as there is may be less bending by the waste collector.

The cart 10 includes a frame 22, two or more shelves 24, 25 for carrying the items 14, 16, 18, a plurality of wheels 26, and a handle 28. The cart 10 also includes at least one advertising panel 30 attached to the cart 10 for displaying advertising 20. As shown the cart 10, includes first advertising panel 30 attached to the left side of the cart 10 and a second advertising panel attached to the right side of the cart 10.

The cart 10 can have an upper shelf 24 and a lower shelf 25. At least one of the shelves 24, 25 can be height adjustable such that the cart 10 can be used for items of different sizes. The cart 10 can have an additional side shelf 32 to expand the carrying capacity of the cart 10 for example, to carry the garbage bin 14. The side shelf 32 is attached to the frame 22 by a shelf bracket 33.

The shelves 24, 25, 32 are attached to the frame 22 via shelf collars 34 and shelf bushings 36. The panel attachment collars 42 may have bushings 44 (e.g. made of plastic) to provide a snug friction fit to the vertical support 40.

The shelf collars 34 each have a tapered shelf bushing 36. The shelf bushings 36 are a two piece construction that snap around the vertical supports 40 of the frame 22. The vertical supports 40 have grooves that accept corresponding ridges on the inner surface of the shelf bushings 36. The grooves and ridges hold the shelf bushings 36 vertically on the vertical supports. The two pieces of the sheif bushings 36 snap together around the vertical supports 40 while the ridges align with the grooves The shelf bushings 36 are tapered upward such that the shelf collars 34 can slide easily over the shelf bushings 36 and be pushed together by hand. Further, once the shelf collar 34 is positioned around the shelf bushings 36, the weight of the shelves 24, 25, 32 will ensure that the shelf collars 34 remain in a snug fit with the shelf bushings 36.

To remove the shelves 24, 25, 32, and disassemble the cart 10, the user taps the shelf collars 34 upward off of the shelf bushings 36. The shelf collars 34 may easily slide upward off of the shelf bushings 36 as the bushing is tapered upward.

The cart 10 including the frame 22 and the shelves 24, 25, 32 can be constructed from metal wire such as all-season weather protected durable chromed steel. The wire frame construction may allow for easy cleaning and provide ventilation of the waste management containers 14, 16, 18.

In some embodiments, the cart 10 includes wheels 26 having locking mechanisms 38 to prevent wheel rotation so that the cart 10 can be left in a stationary position, such as at the pickup location or in the storage area. In some embodiments, the front wheels 26a, 26b (those wheels that are closest to the curb/road) have the locking mechanism 38 such that when the cart 10 is curbside, the wheels 26a, 26b are facing the street and can be locked. The wheels 26 may be attached to the frame 22 by sliding and screwing (e g. via threading) into ends of vertical supports 40. Any or all of the wheels 26 (e.g. the front wheels 26a, 26b) may be swivel wheels. The cart 10 may also include a plurality of bumpers 27 between the wheels 26 and the lower shelf 25 to protect the wheels 26 and the cart 10 when coming into contact with, for example, a wall or a curb.

The advertising panels 30 are removably attached to vertical supports 40 of the frame 22 by panel attachment collars 42 located at top and bottom corners of the advertising panels 30. The location of the panel attachment collars 42 at the corners of the advertising panel 30 may prevent vibration of the advertising panel 30 relative to the vertical supports 40 when in transport. The panel attachment collars 42 may have bushings 44 (e.g. made of plastic) to provide a snug friction fit to the vertical support 40.

The panel attachment collars 42 each have a tapered bushing 44. The bushings 44 (similar to the shelf bushings 36) are a two piece construction that snap around the vertical supports 40 of the frame 22. The vertical supports 40 have grooves that accept corresponding ridges on the inner surface of the bushings 44. The grooves and ridges hold the bushing 44 vertically on the vertical supports. The two pieces of the bushings 44 snap together around the vertical supports 40 while the ridges align with the grooves. The bushings 44 are tapered upward such that the panel attachment collars 42 can slide easily over the bushings 44 and be pushed together by hand. Further once the panel attachment collar 42 is positioned around the bushing 44, the weight of the advertising panel 30 will ensure that the panel attachment collar 42 remains in snug fit with the bushing 44.

To remove the advertising panel 30, the user taps the panel attachment collar 42 upward off of the bushings 44. The panel attachment collars 42 may easily slide upward off of the bushing 44 as the bushing is tapered upward. The removably attachable advertising panels 30 provide easy interchanging of advertising 20. The removably attachable advertising panels 30 may be used, for example, to support a local amateur sports team (e.g. hockey team) for fundraising and the advertising panel 30 can be switched out, as the athlete progresses through sports teams.

The advertising panels 30 are sized to substantially cover a side of the cart to provide a relatively large, flat, vertically extending, surface area for displaying the advertising 20. The advertising panels 30 provide an increased surface area for displaying the advertising 20 as compared to the surface area of the cart without advertising panels. The advertising panels 30 may substantially cover the left and right sides of the cart 10 to provide this increased surface for providing advertising 20. The advertising panels 30 may be for the primary or sole purpose of displaying advertising 20 in the sense that the advertising panels 30 are not required for structural purposes or for the purpose of enclosing the sides of the cart 10. The advertising 20 may be placed on the advertising panel 30 by adhesive decals. The advertising 20 is not placed on an existing surface of the cart but rather on the advertising panel 30. This may be particularly advantageous, as it may be generally undesirable to have the waste management containers 14, 16, 18, enclosed within the cart 10 because, for example, an enclosure may result in complicated structure and higher cost, increased difficulty in loading and unloading the waste management containers 14, 16, 18, and when in use, the waste management containers 14, 16, 18 may contain garbage, recyclables, and other refuse that may cause odors. Accordingly, a well ventilated, open cart 10 may be desirable.

Further, when the cart 10 is placed road-side, stacked with waste management containers 14, 16, 18 and the open shelving is facing a road, the advertising panels 30 are on opposite sides of the cart 10 and face the direction of traffic flow, thus providing a highly visible surface to display the advertising 20. The advertising panels 30 may be on the narrow sides of the cart 10 such that the cart 10, when curbside, does not considerably encroach onto the road.

In some embodiments, the cart 10 has a total weight capacity of 400 lb, with 175 lb per shelf, and 20 to 50 lb for the side shelf 32. The cart 10 may be sized to carry standard sized items 14 16, 18 and be 36 inches in length by 18 inches in width and 42 inches in height.

The upper shelf 24 has three rails: a left rail 50a, a right rail 50b, and a rear rail 50c. The rails 50a, 50b, , 50c, inhibit the containers 18 from failing or blowing off of the upper shelf 24 when in storage, loading, during transport, and when at the pick-up location. The absence of one rail leaves a front side 52 of the upper shelf 24 open for sliding the containers 18 on and off of the upper shelf 24. The containers 18 on the upper shelf 24 may be recycling bins 18, being on the upper shelf 24, the recycling bins 18 may be advantageously positioned with an open top to provide easy access to put recycling items into and out of the recycling bins 18 while in transit or during storage. The upper shelf 24 and the lower shelf 25 have at least one substantially open side to allow for insertion and removal of the waste management containers 14, 16, 18.

The lower shelf 25 has a rear rail 54 to inhibit the containers 16 from falling off of the lower shelf 25 when loading and during transport. A front side 56 of the lower theft 25 is open for sliding in and out of the containers 16. The lower shelf 25 may not have left or right side rails as the advertising panels 30 may inhibit the container from falling off of the lower shelf 25 when loading and during transport.

The rails 50a, 50b, 50c, may be wired frames that slide onto and are sung fit to the shelves 24, 25 and the frame 22.

In use, the cart 10 deployed at the curb may be advantageously positioned with the advertising panels 30 visible to passersby such as those walking or in a vehicle for a high visibility advertising location. In an embedment, the advertising 20 includes advertiserments for local or national goods and services.

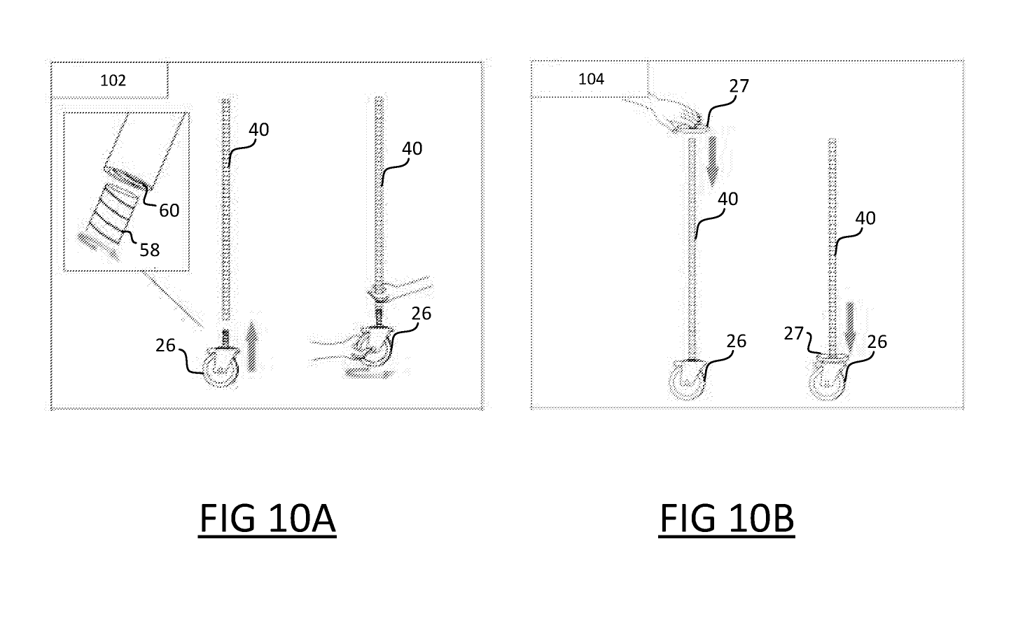

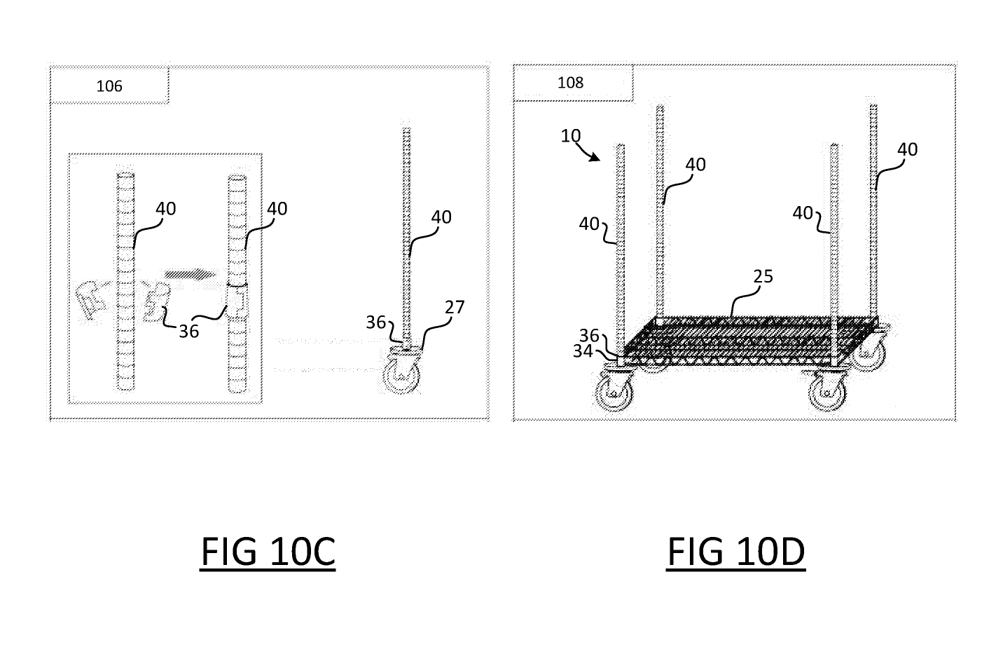

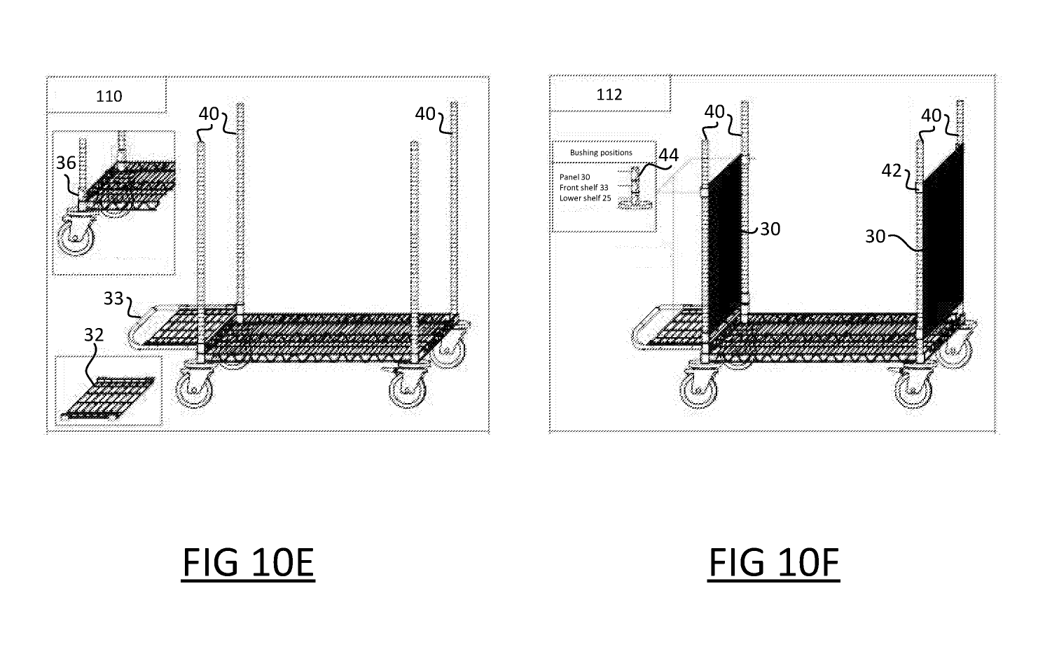

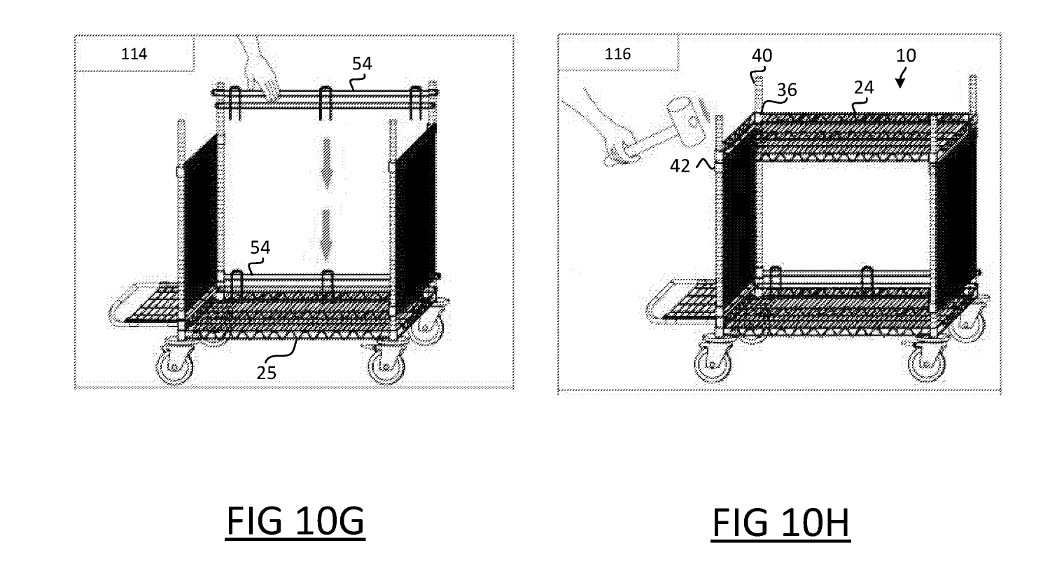

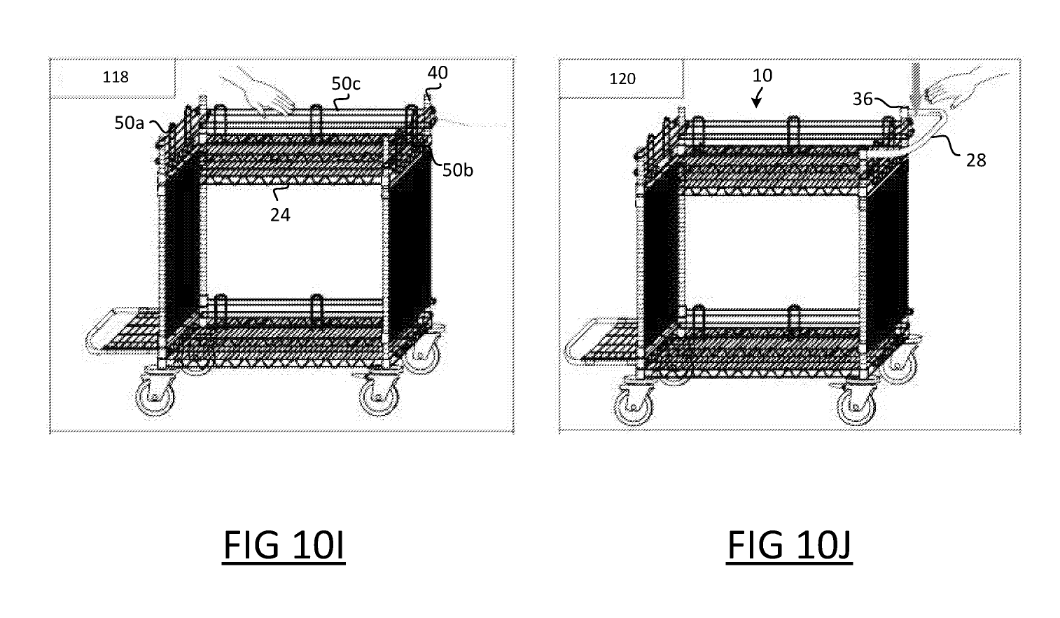

FIGS. 10A-10J illustrate a method for assembling a cart (for example, the cart 10), in accordance with an embodiment. In some embodiments, the method may be done by hand.

At 102, the wheels 26 are connected to the vertical supports 40 via a threaded shaft 58 on the wheel 26 and a corresponding threaded cavity 60 on the vertical supports 40, 102 is repeated for all four vertical supports 40.

At 104, bumpers 27 are slid over the vertical supports 40 to be adjacent to the wheels 26 At 106, the bushings 36 clipped together around the vertical support 40 at a slot above the bumper 27.

At 108, the bottom shelf 25 is slid over the four vertical supports 40 such that the shelf collars 34 fit with the bushings 36 and such that wheels having the locking means are located on a front side of the cart 10. At 110, bushings 36 are clipped together around the vertical supports 40 at the left side of the cart 10. The side shelf bracket 33 is slid onto the vertical support 40 at the left side of the cart 10 onto the bushings 36. The front shelf 32 is pressed onto the front shelf bracket 33 for a friction fit.

At 112, eight sets of bushings 44 are clipped together over the four vertical supports 40 and the advertising panels 30 are slid over the four vertical supports 40 such that the panel attachment collars 42 fit with the bushings 44 and the advertising panels 30 are at the same vertical level.

At 114, the rear rail 54 is pressed onto the bottom shelf 25.

At 116, four sets of bushings 36 are clipped together over the four vertical supports 40 at a slot above the panel attachment collars 42. The top shelf 24 is slid over the four vertical supports 40 such that the shelf collars 34 fit with the bushings 36. Where desired, the shelves 24, 25 may be tapped into place with a rubber hammer or mallet, and may use a protective means such as a towel to protect the cart 10 from cosmetic damage by the rubber hammer.

At 118, the left, right, and rear rails 50a, 50b, 50c, are pressed onto the vertical supports 40 and upper shelf 24.

At 120, two sets of bushings 36 are placed onto the two vertical supports 40 at the right side of the cart 10. The handle 28 is slid over the bushings 36 such that handle collars fit with the bushings 36. While the handle 28 is shown above the upper shelf 24 in the Figures, in an embodiment, the handle 28 is positioned directly above the panel attachment collars 42 and below the upper shelf 24. In this configuration, the handle 28 is secured below the upper shelf 24 on the end of the vertical supports 40.

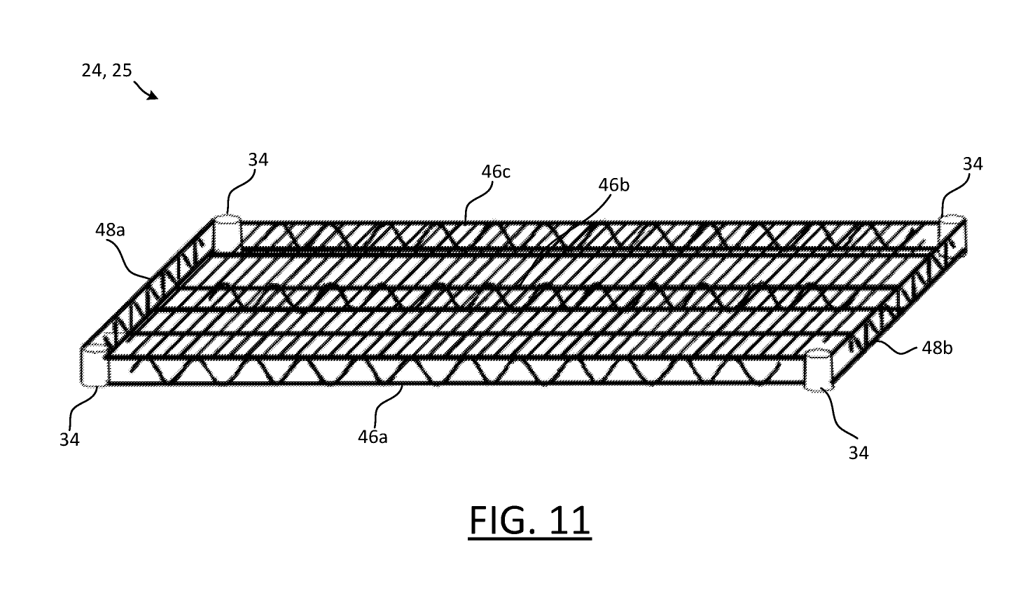

FIG. 11 shows the upper and lower shelves 24, 25 in isolation. The bases of the upper and lower shelves 24, 25 may be similarly constructed. The shelves 24, 25 have three left-to-right ribs 46a, 46b, 46c and two front-to-back ribs 48a, 48b for supporting the shelf. The shelf 24, 25 also has four support bushings 34 for attaching to the vertical supports 40 of the frame 22.

In a further embodiment, the cart has an expanded section of a lower shelf. The expanded section may be suspended or secured with a tie-down extending from an upper shelf or frame of the cart.

While the above description provides examples of one or more apparatus, methods, or systems, it will be appreciated that other apparatus, methods, or systems may be within the scope of the claims as interpreted by one of skill in the art.

1. A cart for transporting waste management containers including containers for garbage, recyclable materials, and compost, the cart comprising:
a frame having vertical supports;
a set of wheels attached to the frame for transporting the cart;
an upper shelf and a lower shelf for supporting the waste management containers, the upper shelf and the lower shelf having at least one substantially open side to allow for insertion and removal of the waste management containers; and
at least one advertising panel removably attachable to the vertical supports for the primary purpose of displaying advertising, the advertising panel being sized to substantially cover a side of the cart to provide an increased surface for displaying advertising.

2. The cart of claim 1 further comprising:
a plurality of panel attachment collars for attaching the advertising panel to the vertical supports of the frame, each of the panel attachment collars being located at a corner of the advertising panel; and
a plurality of bushings for providing a friction fit between the panel attachment collars and the vertical supports.

3. The cart of claim 2, wherein the plurality of bushings are clipped together over the vertical supports and the advertising panels are slid over the bushings and the vertical supports such that the panel attachment collars fit with the bushings.

4. The cart of claim 1, wherein the advertising panel includes a decal for displaying an advertisement.

5. The cart of claim 1, wherein the at least one advertising panel comprises two advertising panels.

6. The cart of claim 5, wherein the two advertising panels comprise a first advertising panel at a first side of the frame and a second advertising panel at a second side of the frame, the second side being opposed to the first side.

7. The cart of claim 1, further comprising:
a handle located at an upper end of the frame.

8. The cart of claim 1, wherein the waste management containers are any one or more of garbage bins, green bins, and recycling bins.

9. The cart of claim 8, wherein the lower shelf is sized to hold two green bins, and the upper shelf is sized to hold two recycling containers.

10. The cart of claim 1, wherein the set of wheels includes two front wheels and two rear wheels, wherein the front two wheels include locking mechanisms for preventing rotation of the wheels.

11. The cart of claim 10, wherein the set of wheels are swivel wheels.

12. The cart of claim 1, wherein the upper shelf includes left, right, and rear rails to inhibit the waste management containers from falling off of the upper shelf.

13. The cart of claim 12, wherein the upper shelf includes an open front side for allowing access to the upper shelf.

14. The cart of claim 1, wherein the cart further comprises a side shelf at a lower end of a left end of the cart.

15. The cart of claim 14, wherein the upper shelf is configured to support bins of recycling materials, the lower shelf is configured to support bins for organic material, and the side shelf is configured to support bins for garbage material.

16. The cart of claim 1 further comprising:
an expanded section of the lower shelf; and
a tie-down extending from the upper shelf or frame to secure the expanded section of the lower shelf.

17. The cart of claim 1 wherein the upper and lower shelf each include a plurality of ribs for reinforcing the shelf, wherein the shelf includes three ribs running in a first direction and two ribs running in a direction perpendicular to the three ribs.

18. The cart of claim 1 wherein the advertising panel comprises a metal sheet of 0.5 mm to 4 mm.

19. A method for assembling the cart of claim 1, the method comprising:
attaching a frame to a lower shelf;
attaching the frame to the upper shelf; and
attaching at least one advertising panel to the frame.
